(19) United States
(12) Patent Application Publication
(10) Pub. No.: US 2026/0203920 A1
(43) Pub. Date: Jul. 16, 2026

(54) SPATIALLY MODELING AN ENVIRONMENT

(71) Applicant: Telefonaktiebolaget LM Ericsson (publ), Stockholm (SE)

(72) Inventors: Fernando dos Santos BARBOSA, Stockholm (SE); Erik WARBERG, Huddinge (SE); Adam MIKSITS, Stockholm (SE); Roberto CASTRO SUNDIN, Stockholm (SE); Alejandra HERNANDEZ SILVA, Stockholm (SE); Magnus LINDHÉ, Stockholm (SE); Paula CARBÓ CUBERO, Stockholm (SE)

(73) Assignee: Telefonaktiebolaget LM Ericsson (publ), Stockholm (SE)

(21) Appl. No.: 19/135,446

(22) PCT Filed: Dec. 12, 2022
(86) PCT No.: PCT/EP2022/085376

§ 371 Date: Jun. 4, 2025

(51) Int. Cl. G06T 7/50

(52) U.S. Cl. CPC G06T 7/50; G06T 2207/20081

(57) ABSTRACT

A method of spatially modeling an environment includes acquiring new depth sensor measurements from a depth sensor indicating points on at least one physical surface of the environment. The method spatially prunes the new depth sensor measurements to add particular ones of the new depth sensor measurements to a cumulative set of depth sensor measurements which satisfy a condition for being at least a pruning-based threshold distance away from any depth sensor measurements already in the cumulative set of depth sensor measurements. The method updates a Gaussian Process model representation of a Euclidean distance field on the environment using at least the particular ones of the new depth sensor measurements added to the cumulative set of depth sensor measurements.

### TECHNICAL FIELD

The present disclosure relates to a method of spatially modeling an environment and a corresponding computing device.

### BACKGROUND

Gaussian Processes (GPs) are state-of-the-art tools for non-parametric modelling and non-linear multivariate interpolation based on a dataset of (noisy) samples from the process to be modelled. Despite its great capabilities in building model approximations, GPs scale poorly with the amount of data (i.e. size of the dataset); furthermore, GPs were originally designed as a tool for post-processing the whole dataset, without considerations on how to swiftly integrate new data. Several researchers have aimed at tackling this issue in order to provide GPs that scale better with the amount of data as well as to allow for real-time integration of data and model update. For example, reference [1] defines Streaming Sparse GPs, providing the theoretical background that allows for real-time integration of new data along with model optimization based on inducing points. In short, inducing points can be thought of as a way of approximating the original dataset, with the optimization step attempting to distribute them as to build an optimal approximation.

FIG. 1 illustrates example graphs of a streaming GP application relative to a time-series. FIG. 1 provides an example visualization of the operations presented in reference [1]. The process is illustrated at three time-steps, with “X” markers showing the sampled data (where “X” markers in darker black indicate those most recently added to the model, while other “X” markers in lighter gray indicate previous samples already added to the dataset at a previous time step), the circular dots are the inducing points, and the shaded envelope regions represent the current model approximation with confidence interval. FIG. 1 illustrates how the locations of the inducing points change as new data is added.

Robotic systems require a way of spatially representing the environment in which they are operating. Occupancy maps are discrete spatial representations of the environment, which divide the space into cells (or voxels) of equal size. Each cell can be labelled as free, occupied, or unknown. Even though occupancy grid map algorithms are very common among practitioners, especially due to their simplicity, they suffer from a few issues. Among them, the lack of some relation between neighboring cells, since each cell is assumed to be completely independent from the others. Euclidean distance fields (EDFs) appeared as a more robust and informative approach for surface representation of objects. A Euclidean distance field is a function that for each given point in space, gives the Euclidean distance to a nearest surface of an obstacle and which may also be represented as the orthogonal distance of the given point to the surface. Although commonly treated in a discrete way, similarly to grid maps, some researchers have defined approaches for continuous approximations. For example, reference [2] represents a state-of-the-art approach for real-time modelling of continuous distance fields in two-dimensions (2D) while using a Lidar sensor. Since it builds on the use of GPs, so as to have continuous approximations, central operations of reference [2] are directed to dealing with data scalability. The operations divide the space in overlapping clusters, and create one local model in each cluster, i.e. one GP per cluster. Some further operations are directed to treating new incoming sensor data (mainly for identifying to which cluster(s) a sample belongs), local model updates, and distance prediction (which cluster(s) to use for prediction).

Continuous approximations of distance fields are useful for planning and control of dynamic systems, such as mobile robots and computer controlled manipulators. Reference [3] discloses operations directed to using continuous EDFs for collision avoidance. Even though reference [3] does not build on reference [1], the operations use a covariance kernel that is better suited for modelling distance fields, and therefore generates better approximations. Furthermore, reference [3] demonstrates how GPs can be used to build approximations of the first and second derivatives of the distance field, which can again be used for planning and control purposes.

Although reference [1] is a state-of-the-art approach for real-time modelling using GPs, a generic method is disclosed for doing so and which is not adapted based on consideration of the data (or its quality) being fed into the model, or to specificity of the kernels and how to choose or optimize the model parameters. Furthermore, the operations leave the task of deciding the number of inducing points as an open problem, and do not address how to add or remove inducing points, nor how to decide when to do so. Lastly, the operations do address that the location of the inducing points can be optimized together with the model optimization by making them one of the parameters to be adjusted. It has been determined in the present disclosure that the majority of the inducing points would accumulate very close to the data most recently added to the dataset, while the “old part” of the dataset would fall scarce of inducing points which has a negative effect on the quality of the approximation.

Regarding the operations proposed in reference [2], flaws arise in the several complex and computationally expensive steps required for building the model, and in the lack of a clear approach for extending the operations to 3D and to other sensors besides Lidars. In order to deal with the amount of data, which is the biggest problem with general types of GPs, reference [2] discloses a complicated data structure with overlapping clusters, so that each cluster can be modeled by 1 GP, therefore limiting the amount of data. Reference [2] does not disclose how to manage the clusters, how to add new clusters if necessary, and how to decide cluster size or how much clusters overlap each other. The disclosed operations also require overly complex data processing before adding to a GP. The data processing can involve raytracing, data extrapolation, occupancy testing, calculation of surface normals, among others. Furthermore, it is problematic that the operations generate only a truncated version of the EDF, which is precise only in the vicinity of the obstacles, and which precision then deteriorates quickly at slightly larger distances. The operations are also computationally burdensome, requiring relatively high computing resource allocation and/or slower computational cycles.

The operations of Reference [3] rely on full knowledge about the dataset prior to mission deployment. Therefore, the operations do not address matters with sensor processing, model updates or optimization, and real-time data integration. Reference [3] does not address any issues related to the size of the dataset and how it can impact real-time use of the model.

### SUMMARY

Some embodiments disclosed herein are directed to a method of spatially modeling an environment. The method includes acquiring new depth sensor measurements [symbol] from a depth sensor indicating spatial distance away from at least one physical surface of the environment. The method further includes spatially pruning the new depth sensor measurements [symbol] to add particular ones of the new depth sensor measurements to a cumulative set [symbol] of depth sensor measurements which satisfy a condition for being at least a pruning-based threshold distance away from any depth sensor measurements already in the cumulative set [symbol] of depth sensor measurements. The method further includes updating a Gaussian Process model representation of Euclidean distance fields on the at least one physical surface of the environment using at least the particular ones of the new depth sensor measurements added to the cumulative set [symbol] of depth sensor measurements.

Some other related embodiments disclosed herein are directed to a computing device that includes at least one processor and at least one memory storing instructions executable by the at least one processor to perform operations. The operations include to acquire new depth sensor measurements [symbol] from a depth sensor indicating spatial distance away from at least one physical surface of the environment. The operations further include to spatially prune the new depth sensor measurements [symbol] to add particular ones of the new depth sensor measurements to a cumulative set [symbol] of depth sensor measurements which satisfy a condition for being at least a pruning-based threshold distance away from any depth sensor measurements already in the cumulative set [symbol] of depth sensor measurements. The operations further include to update a Gaussian Process model representation of Euclidean distance fields on the at least one physical surface of the environment using at least the particular ones of the new depth sensor measurements added to the cumulative set [symbol] of depth sensor measurements.

Potential advantages that may be provided by these and other embodiments disclosed herein include that use of the spatial pruning can avoid any need for an optimization step following updating of the Gaussian Process model. No data extrapolation is required when updating the Gaussian Process model using the new depth sensor measurements. A single Gaussian Process model may be used to accurately represent the Euclidean distance field over even a relatively large environment.

Other methods and computing devices according to embodiments will be or become apparent to one with skill in the art upon review of the following drawings and detailed description. It is intended that all such methods and computing devices be included within this description, be within the scope of the present disclosure, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 illustrates example graphs of a streaming GP application relative to a time-series;

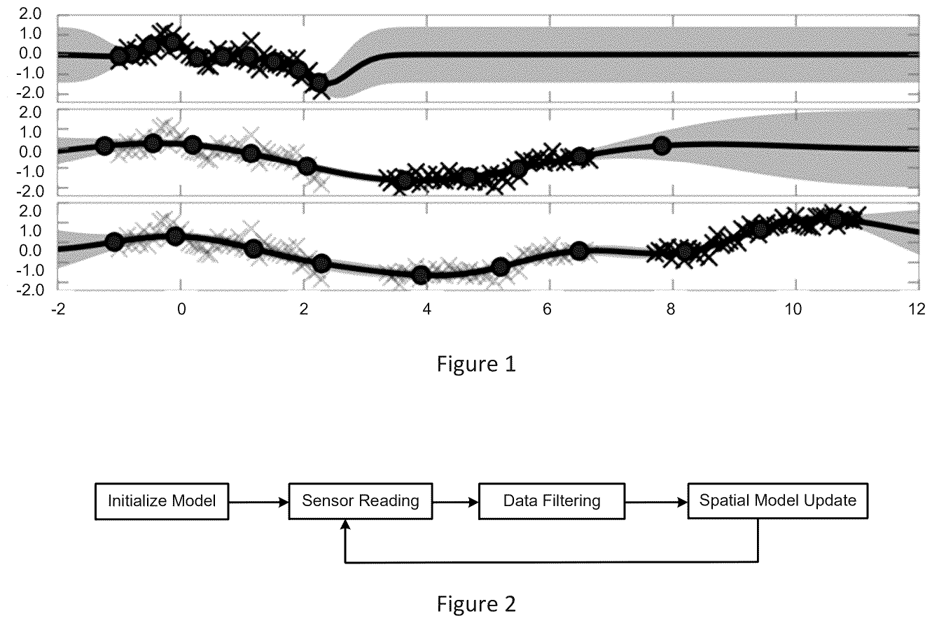

FIG. 2 illustrates example operations for updating a GP model representation of a Euclidean distance field based on sensed points on the at least one physical surface of the environment, in accordance with some embodiments of the present disclosure;

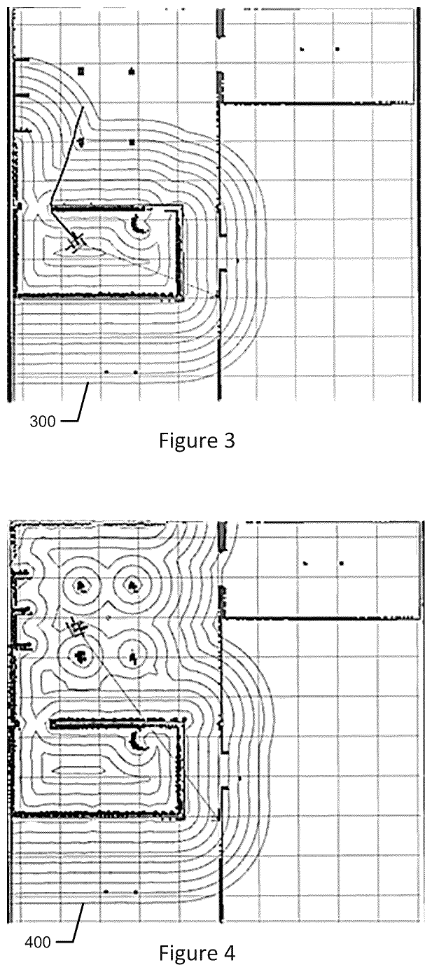

FIG. 3 illustrates a Euclidean distance field represented in a GP model of the environment after updating using a first set of sensor measurements by a spatial sensor of a robot in accordance with some embodiments of the present disclosure;

FIG. 4 illustrates a Euclidean distance field represented in the GP model of the environment after further updating using a second set of sensor measurements after the robot has moved performing further sensing using the spatial sensor, in accordance with some embodiments of the present disclosure;

FIG. 5 illustrates two pointclouds of sensor measurements, with the pointcloud on the left illustrating the raw set of depth sensor measurements and the pointcloud on the right illustrating the sparsified set of depth sensor measurements in accordance with some embodiments of the present disclosure;

FIGS. 6A to 6L illustrates a sequence of operations performed on spatial sensor measurements to update a GP model representation of a Euclidean distance field on a horizontal wall surface and connected vertical wall surface of a room in accordance with some embodiments of the present disclosure;

FIG. 7 illustrates a flowchart of operations for updating a Gaussian Process model representation of a Euclidean distance field in accordance with some embodiments of the present disclosure; and

FIG. 8 illustrates a block diagram of components of a system that are configured to operate in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of various present inventive concepts to those skilled in the art. It should also be noted that these embodiments are not mutually exclusive. Components from one embodiment may be tacitly assumed to be present/used in another embodiment.

Various embodiments of the present disclosure are directed to updating a Gaussian Process model representation of a Euclidean distance field on physical surface(s) of an environment using depth sensor measurements from a depth sensor. The surface(s) can correspond to any type of physical objects, e.g., walls, doors, ceiling, furniture, etc. in a sensed region of the environment.

Operations according to some embodiments represent a Euclidean distance field (EDFs) as a single Gaussian Process (GP) for the entire environment. The operations are configured to be scalable to large environments and to allow for incremental real-time updates when new depth sensor measurements become available. The operations may use the depth sensor measurements of the surface(s) as inducing points for updating a GP model representation of surfaces of the environment, and replace the optimization step for inducing points described in the above-noted references with a computationally efficient spatial pruning operational step. The resulting operations for updating the GP model may be performed faster and more computationally efficient than the operations described in the above-noted references, and may also provide a much less complicated data structure than reference [2].

Some embodiments of the present disclosure are directed to using a single GP to represent the EDF by a set of inducing points, where the inducing points correspond to locations along an object surface in the environment being spatially modeled. The GP can use a kernel configured to represent the inducing points along the object surface, the inducing points can be selected by spatial pruning, and the inducing points can be added to the GP model if they are at least a threshold distance away from points already in the dataset of the model.

The above-noted references disclose operations which require an optimization step after new depth sensor measurements are used to update a GP model representation of surface(s) in an environment, since it is at this step that the disclosed operational hyperparameters are tuned to better fit the GP model to the new depth sensor measurements. In contrast, various embodiments of the present disclosure are directed to operations that do not require an optimization step after new depth sensor measurements are used to update a GP model representation of surface(s) in an environment. It has been presently determined that a spatial pruning step can be operationally important for not only maintaining numerical stability in the GP model, but also to managing the depth sensor measurements and resulting inducing points of the GP model. Therefore, the optimization step described in the above-noted references can be replaced with a spatial pruning step in accordance with some embodiments of the present disclosure.

A potential benefit of operations described below for various embodiments of the present disclosure, is that the operations do not require complicated data extrapolation steps which have been used with the above-noted references. For example, the operations of reference [2] expand the set of depth sensor measurements, which is to be used to update to the GP model, with virtual measurements at a certain distance from the surface to attempt to ensure the GP model converges. Without the extrapolated of depth sensor measurements, the GP model may fail to build an approximation of the EDF, e.g., because all of the depth sensor measurements in the set are at distance zero to the closest surface and which can cause the GP model to learn that the distance is zero everywhere in the environment. Furthermore, besides data extrapolation being a computationally expensive step on its own, a larger set of depth sensor measurements also affects the accuracy of the GP model representation of the surface(s) since it scales poorly with the size of the set.

Potential advantages that may be provided by one or more embodiments of the present disclosure can include any one or more of:
No need for an optimization step, which is instead replaced by a spatial pruning step;
No data extrapolation required for constructing the set of depth sensor measurements used to update the GP model;
Simpler data structure than reference [2], requiring neither several overlapping GP models nor an assumption on the size of the environment, as well as being applicable to both 2D and 3D; and
Allows for a single GP to be used to model large environments.

The term depth sensor is used herein to refer to any sensor capable of generating an indication of distance between the senor and a closest obstacle surface. Examples of depth sensors include, but are not limited to, Lidars, radars, sonars, RGB-D cameras, stereo cameras, etc. Depth sensors can be integrated into mobile robots and other mobile devices to capture samples from surface(s) of obstacles, and therefore enable spatial model reconstruction.

An example operational algorithm and associated process that can be used with some embodiments of the present disclosure are now discussed.

Let z: [symbol] be a process from which a computing device can obtain measurements \hat{z}: [symbol] of the EDF at some point x on the surface of an obstacle, from a depth sensor. The measurements can be modeled as

$$\hat{z} ( x ) = z ( x ) + ϵ$$

where

$$ϵ ∼ 𝒩 ( 0 , {σ}_{n}^{2} )$$

is zero-mean additive noise, which represents the uncertainty in the location of x.

Let the belief over the process be modeled as a zero-mean GP with covariance (kernel) κ: [symbol] A data set of N (noisy) EDF measurements is given by

$$𝒟 = {\{ {x}_{i} , \hat{z} ( {x}_{i} ) \}}_{i = 1}^{N} ,$$

with xᵢ∈ [symbol] . The posterior belief of z at a position x*, conditioned on the data set [symbol] , is given by z(x*)| [symbol] ~ [symbol] (z̅(x*),V[z(x*)]).

Instead of using GP regression to approximate the EDF directly, reference [3] approximates the heat diffusion function φ and uses a mathematical relation to retrieve the EDF d̅. Given a set of noisy EDF measurements

$$𝒟 = {\{ {p}_{i} , \hat{d} ( {p}_{i} ) \}}_{i = 1}^{N}$$

with pᵢ a position in the environment, anew one

$${𝒟}^{′} = {\{ {p}_{i} , \hat{ϕ} ( {p}_{i} ) \}}_{i = 1}^{N}$$

must be derived exploiting the relation \hat{φ}(pᵢ)=e^{-λ\hat{d}(p}^{ᵢ}⁾. Then, the posterior belief of φ at a position p*, conditioned on the data set [symbol] , is given by φ(p*)| [symbol] ~ [symbol] (φ̅(p*),V[φ(p*)]). Having obtained an approximation of φ, the operations no derive the posterior belief of the distance field d at a position p*, conditioned on φ(p*), as d(p*)|(p*)~ [symbol] (d̅(p*),V[d(p*)]). The predictive distance d̅ at a query point p* can then be retrieved by

$$\overline{d} ( {p}^{*} ) = - \frac{1}{λ} ln \overline{ϕ} ( {p}^{*} ) .$$

In the following description, the kernel to be used can be defined as the one proposed in reference [3], i.e. a Matern kernel with ρ=\sqrt{(2ν)}/λ, with ν the degree of the kernel (ν=0.5 recommended) and λ a parameter directly related to the precision of the approach (λ=100 recommended). Furthermore, the operations may be restricted to using only samples of the obstacle surfaces where d=0 (and therefore φ=1), and which allows to maintain a set [symbol] of positions pᵢ only instead of pairs of position-distance, and which reduces the amount of memory used by the operations. Note that [symbol] begins as an empty set and is incrementally updated as new depth sensor measurements are processed.

The operations may require access to the implementation of a GP approach that allows for efficient data integration in real time. A state-of-the-art approach is described in reference [1], which employs variational free energy inference and learning, and describes how the operations define a set of inducing points Pina (referred to as “pseudo-points” in [1]) for faster learning and model optimization. Operations according to various presently disclosed embodiments are not limited to the operations disclosed in reference [1] or other references herein, and may be used with any GP model, with inducing points, representing a Euclidean distance field on physical surface(s).

In accordance with some embodiments of the present disclosure, the sets [symbol] and P_{ind} (inducing points) have the same elements and are, therefore, equal. However, it can be important to differentiate between the two sets because of their purposes in the operations described herein. The set [symbol] is maintained for use in the spatial pruning step. The set P_{ind} is required by the GP and does not necessarily need to be equal to [symbol] , as clarified in one of the alternative embodiments described below. Operational steps that can be performed according to some embodiments of the present disclosure are now described.

Operational step 1 initializes a GP model as well as empty sets [symbol] and P_{ind}.

Operational step 2 performs a real-time EDF approximation, which can include the following sub-operational steps:
a) Using a depth sensor, acquire obstacle surface points

$$\text{?} = {\{ {p}_{i} \}}_{i = 1}^{N}$$

(where the EDF has value 0) in a global coordinate system used for modeling the environment.
b) Perform spatial pruning through operations that can include the following:
   i. Initialize an empty set [symbol]
   ii. For each obstacle surface point pᵢ∈ [symbol] , add pᵢ to [symbol] and [symbol] , if a condition is satisfied by pᵢ being farther than a threshold distance dₘᵢₙ from any point in [symbol] .
c) Update the GP model, which can include the following sub-operational steps:
   i. Let IndP:=IndP∪ [symbol]
   ii. Update the GP model, e.g., in an online fashion, which may be based on the operations disclosed in reference [1]. These operations include sending [symbol] and P_{ind} to the GP, with φ(pᵢ)=1 for pᵢ∈ [symbol] , as clarified in the previous subsection but excluding any hyperparameter optimization step.

Operational step 3 repeats the operations of Operational step 2 responsive to obtaining new sensor measurements.

Various additional or alternative operations are now described in accordance with some further embodiments of the present disclosure.

In the above description, the spatial pruning Operational step 2b above can be implemented in two operational sub-steps, which may be computed relatively fast and with relative high computational efficiency. In the first operational sub-step, the depth sensor measurements of [symbol] are sparsified using voxel grid downsampling with a grid size dₘᵢₙ, which generates sparser, but more evenly distributed, depth sensor measurements data. In the second operational sub-step, operations may use a spatial tree, such as KD-trees, to compare the depth sensor measurements data coming from the previous step with [symbol] , adding to [symbol] and [symbol] only depth sensor measurements datapoints that are farther than the threshold dₘᵢₙ. Embodiments of the present disclosure are not limited to use of spatial trees and may instead using other techniques, such as an exhaustive search.

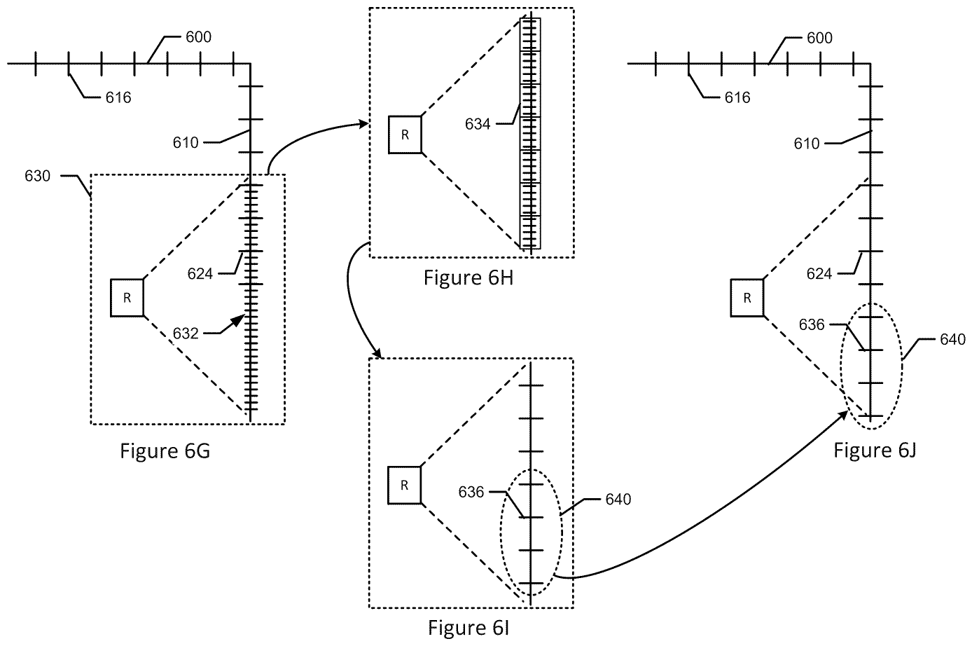

The operations may be improved for scalability in large environments by making P_{ind} a subset of [symbol] in Operational step 2c above. However, the subset of [symbol] should be found in a spatially-correct manner, i.e. P_{ind} should be spatially distributed in a way that approximates [symbol] . FIG. 5 illustrates two pointclouds of sensor measurements, with the pointcloud on the left illustrating the raw set of depth sensor measurements and the pointcloud on the right illustrating the sparsified (e.g., downsampled) set of depth sensor measurements in accordance with some embodiments of the present disclosure. The operations may use a KD-tree to sparsify (e.g., downsample) the depth sensor measurements in a spatially-correct manner. The downsampling operations may, for example, be based on Alg. 3 from “ikd-Tree: An Incremental K-D Tree for Robotic Applications”, by Y. Cai, W. Xu, and F. Zhang, https://arxiv.org/pdf/2102.10808.pdf, arXiv, 2021.

A computationally simplistic way of creating P_{ind} is to downsample [symbol] using voxel grid downsampling with a grid size larger than dₘᵢₙ and, for each cell, select the datapoint closest to the center of the cell.

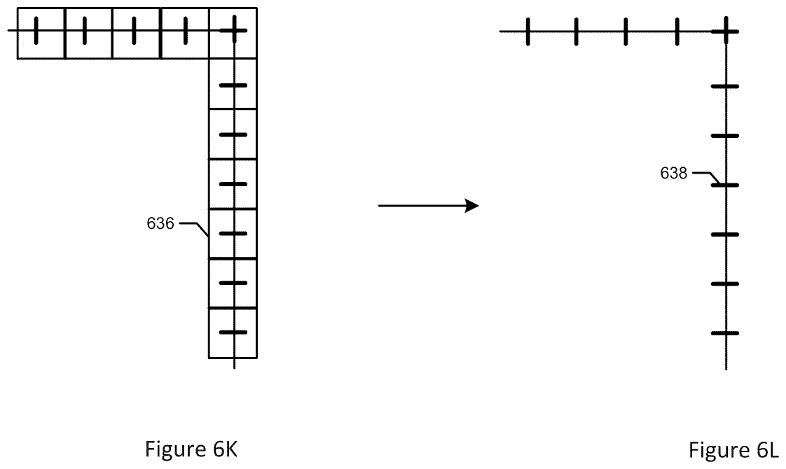

The sparsification and spatial pruning may be performed according to any one or more of the following embodiments. FIGS. 6A to 6L illustrates a sequence of operations performed on spatial sensor measurements to update a GP model representation of a Euclidean distance field on a horizontal wall surface 600 and a connected vertical wall surface 610 of a room in accordance with some embodiments of the present disclosure. The illustrated steps 1-7 are sub-steps of step 2 in the above description, and are therefore referred to as “Operational sub-steps”.

Operational sub-step 1—Referring to FIG. 6A, initially a robot (R) is oriented so that its depth sensor(s) is facing the horizontal wall surface 600. The depth sensor(s) provides outputs which are processed to generate depth sensor measurements (data) [symbol] illustrated as the vertical hash lines 612 intersecting the horizontal wall surface 600. It is noted that the number of hash lines and the spacing between the hash lines (sensor readings [symbol] ) in FIGS. 6A-6L were determined for convenience of illustration and do not provide a limitation for any of the embodiments.

Operational sub-step 2—Referring to FIG. 6B, sparsification through voxel grid downsampling is performed on the depth sensor measurements [symbol] within each of the virtual grids 614, illustrated as rectangles, to generate downsampled depth sensor measurements. Operations also initialize an empty set [symbol] . The sparsification results in the downsampled depth sensor measurements 616 not including any of the new depth sensor measurements 612 that are within a sparsity-based threshold distance away from other of the new depth sensor measurements. In the context of grid based downsampling, for each virtual grid 614 in the array of virtual grids that are arranged along at least part of the range of the new depth sensor measurements 612, the operations leave only one of the new depth sensor measurements that is within the virtual grid 614 and satisfies a condition for being at least the sparsity-based threshold distance away from the new depth sensor measurements within adjacent virtual grids in the array. The condition may further require that the depth sensor measurement selected within the virtual grid 614 provide more even distribution relative to the new depth sensor measurements within the adjacent virtual grids in the array.

Operational sub-step 3—Referring to FIG. 6C, the resulting downsampled set [symbol] and set [symbol] have downsampled depth sensor measurements (spatial locations) illustrated by the intersections between the horizontal wall surface 600 and the larger hash lines 616 compared to the more numerous smaller hash lines in FIGS. 6A and 6B.

Operational sub-step 4—Referring to FIG. 6D, the robot R performs another cycle of depth sensor measurements of the environment after rotating right 90 degrees toward the vertical wall surface 610. New depth sensor measurements (data) 620 are illustrated as the horizontal hash lines intersecting the vertical wall surface 610.

Operational sub-step 5—Referring to FIG. 6E, sparsification through voxel grid downsampling is performed on the new depth sensor measurements within each of the virtual grids 622, illustrated as rectangles, to generate downsampled depth sensor measurements. Operations also re-initialize empty set [symbol] . Through similar operations to those described with Operational sub-step 2, the sparsification results in the downsampled depth sensor measurements 624 not including any of the new depth sensor measurements 620 that are within a sparsity-based threshold distance away from other of the new depth sensor measurements. In the context of voxel grid based downsampling, for each virtual grid 622 in the array of virtual grids that are arranged along at least part of the range of the new depth sensor measurements 620, the operations leave only one of the new depth sensor measurements 624 that is within the virtual grid 622 and satisfies a condition for being at least the sparsity-based threshold distance away from the new depth sensor measurements within adjacent virtual grids in the array. The condition may further require that the depth sensor measurement selected within the virtual grid 622 provide more even distribution relative to the new depth sensor measurements within the adjacent virtual grids in the array.

Operational sub-step 6—Referring to FIG. 6F, the resulting set [symbol] now includes the downsampled depth sensor measurements 616 (spatial locations illustrated by the larger hash marks along the horizontal wall surface 600) determined in Operational sub-step 3 above (FIG. 6C) along with the downsampled depth sensor measurements 624 (spatial locations illustrated by the larger hash marks along the vertical wall surface 610). It is noted that set [symbol] , here contains only the newly added downsampled depth sensor measurements 624 illustrated by the larger hash marks along the vertical wall surface 610, and therefore set [symbol] is no longer equal to set [symbol] .

Operational sub-step 7—Referring to FIG. 6G, the robot R has moved downward and has performed another cycle of depth sensor measurements using the depth sensor(s) facing another region 630 of the vertical wall surface 610. New depth sensor measurements (data) 632 are illustrated by the smaller horizontal hash lines intersecting the vertical wall surface 610 within region 630. Referring to FIG. 6H, sparsification through voxel grid downsampling is performed on the new depth sensor measurements 632 in region 630 within each of the virtual grids 634, illustrated as rectangles, to generate downsampled depth sensor measurements 636. Operations also re-initialize empty set

[symbol]

Spatial pruning is performed to determine a subset of which of the downsampled depth sensor measurements 636 are to be added to the set [symbol] . The operation for spatially pruning selects the particular ones of the downsampled depth sensor measurements 636 to be added to the cumulative set [symbol] of depth sensor measurements which satisfy a condition for being at least a pruning-based threshold distance away from any depth sensor measurements already in the cumulative set [symbol] of depth sensor measurements. Referring to FIG. 6I, the downsampled depth sensor measurements 636 within region 640 are identified as satisfying the condition (at least the pruning-based threshold distance away) for addition to the set [symbol] , and which are also included in the set [symbol] . As a result, set [symbol] includes the downsampled depth sensor measurements 616 illustrated in FIG. 6J by the vertical hash lines along the horizontal wall surface 600 and the downsampled depth sensor measurements 624 and 636 illustrated by horizontal hash lines along the vertical wall surface 610. In contrast, set [symbol] includes only the new downsampled depth sensor measurements 636 illustrated in FIG. 6J by the horizontal hash lines along the vertical wall surface 610 in region 640. When downsampling is performed using voxel grid downsampling in accordance with some embodiments, only the subset of downsampled depth sensor measurements 636 that are farther than a defined threshold dₘᵢₙ from set [symbol] are added to both set [symbol] and to set [symbol] .

Through the above-Operational sub-steps 1-7, the sparsification and spatial pruning operations are used to determine which of the depth sensor measurements from the depth sensor measurements are added to the cumulative set [symbol] . The two data sets [symbol] and [symbol] can be used to update a GP model representation of a Euclidean distance field through points on the horizontal wall surface 600 and the vertical wall surface 610.

In some further embodiment, instead of using all of the depth sensor measurements in set [symbol] to update the GP model, a set of inducing points P_{ind} are selected from among the depth sensor measurements in set [symbol] , and the inducing points P_{ind} are used to update the GP model. As explained above with regard to Operational step 2c, the operations may be improved for scalability in large environments by making P_{ind} a subset of [symbol] in Operational step 2c above. However, the subset of [symbol] should be found in a spatially-correct manner, i.e. P_{ind} should be spatially distributed in a way that approximates [symbol] . Example operations for generating P_{ind} are now described with regard to Operational sub-step 8.

Operational sub-step 8—Referring to FIGS. 6K and 6L, a computationally simplistic way of creating P_{ind} is to downsample [symbol] using voxel grid downsampling with a grid size larger than dₘᵢₙ and, for each cell, select the datapoint closest to the center of the cell. Virtual grids 636 with a grid size larger than dₘᵢₙ are arranged along the ranges of the depth sensor measurements in set [symbol] . One of the depth sensor measurements 638 that is closest to the centers of each of the virtual grids 636 is selected, and added to set P_{ind}. Set P_{ind} of inducing points is then used to update the GP model.

The pruning-based threshold distance and the sparsity-based threshold distance (e.g., threshold dₘᵢₙ of the virtual grids) can be determined through experimentation and/or other operational techniques. In some embodiments, operations define a parameter EDFₘᵢₙ that indicates a desired precision of the GP-based EDF approximation. For example, EDFₘᵢₙ=0.1 m indicates that the GP model should be precise anywhere in the environment that is farther than 10 cm from any surface. The threshold can then be defined as, e.g., dₘᵢₙ<EDFₘᵢₙ/1.5. The pruning-based threshold distance and the sparsity-based threshold distance may therefore be determined based on the desired precision of the GP-based EDF approximation.

Some embodiments may be performed by offloading various operations to networked computing resources, e.g., with the GP model update (Operational step 2c) performed by an edge or cloud device. Depth sensor measurements data can be streamed to the edge or cloud device in at least three opportunities within Operational step 3: (i) raw (unfiltered depth sensor measurements data) is uploaded; (ii) downsampled depth sensor measurements data (after Operational step 2b) is uploaded; (iii) filtered depth sensor measurements data (after step 2c) is uploaded. The choice will depend on the processing power of the mobile device, e.g., robot.

Some embodiments may be performed with offline operations, e.g., through a post-processing tool. The operations can follow the same structure as presented in Operational steps 1-4, with one difference that Operational step 2 would process a complete dataset of depth sensor measurements acquired in a previous robot mission.

Some embodiments may be applied to 2D or 3D mesh representations of objects and environments, which could be built from depth sensor measurements or directly from computer-generated environments (such as CAD programs or simulators). In known prior art approaches, meshes cannot be used for motion planning and control algorithms because such meshes do not provide any easy collision checking algorithm, and do not provide a metric for distance to closest obstacle. In contrast, various embodiments disclosed herein can use vertices of a mesh as readings of a depth sensor.

In order to reduce computational power required, the GP model (Operational step 2c) can be updated at lower frequency rates than the operations for depth sensor measurements (Operational step 2a) and the operations for spatial pruning (Operational step 2b). GP model updates can be triggered according to distance travelled since last update, amount of new data accumulated, among others.

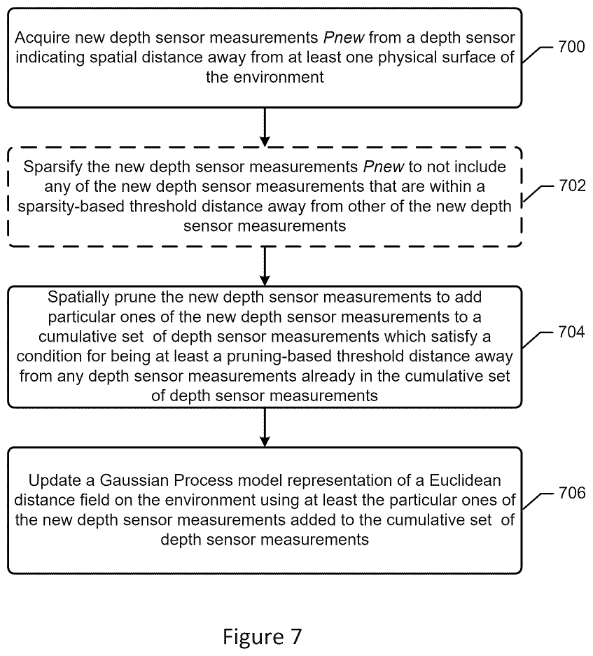

Numerous example embodiments have been described with particularity for completeness of explanation and to simplify the implementation of a computing device. However, other embodiments are not limited to these embodiments and can be performed based on more generalized operations. FIG. 7 illustrates a flowchart of operations that may be performed by a computing device for updating a Gaussian Process model representation of a Euclidean distance field in accordance with some embodiments of the present disclosure.

Referring to FIG. 7, the operations acquire 700 new depth sensor measurements [symbol] from a depth sensor indicating spatial distance away from at least one physical surface of the environment. The operations may sparsify 702 the new depth sensor measurements [symbol] to not include any of the new depth sensor measurements that are within a sparsity-based threshold distance away from other of the new depth sensor measurements. The operations spatially prune 704 the new depth sensor measurements [symbol] to add particular ones of the new depth sensor measurements to a cumulative set [symbol] of depth sensor measurements which satisfy a condition for being at least a pruning-based threshold distance away from any depth sensor measurements already in the cumulative set [symbol] of depth sensor measurements. Although the operation to sparsify the new depth sensor measurements is described as being performed in combination with the operation to spatially prune the new depth sensor measurements, the operation to sparsify is optional such that the spatial pruning may be performed without performing sparsification. The operations update 706 a GP model representation of a Euclidean distance field on the at least one physical surface of the environment using at least the particular ones of the new depth sensor measurements added to the cumulative set [symbol] of depth sensor measurements.

The operation to sparsity 702 the new depth sensor measurements may include to, for each virtual grid in an array of virtual grids that are arranged along at least part of a range of the new depth sensor measurements, leave only one of the new depth sensor measurements that is within the virtual grid and satisfies a condition for being at least the sparsity-based threshold distance away from the new depth sensor measurements within adjacent virtual grids in the array.

Additionally, the operation to sparsify 702 the new depth sensor measurements may include to, for each virtual grid in an array of virtual grids that are arranged along at least part of the range of the new depth sensor measurements, leaving only one of the new depth sensor measurements that is within the virtual grid and satisfies the condition for being at least the sparsity-based threshold distance away from the new depth sensor measurements within adjacent virtual grids in the array and providing more even distribution relative to the new depth sensor measurements within the adjacent virtual grids in the array. The operation to sparsify 702 may include to downsample the new depth sensor measurements using a voxel grid filter operating with a minimum virtual grid size defined based on the sparsity-based threshold distance. The downsampling of the new depth sensor measurements using a voxel grid filter, may operate to downsample the new depth sensor measurements using the voxel grid filter operating with a minimum virtual grid size that is greater than sparsity-based threshold distance, and then within each of the virtual grids, select one of the new depth sensor measurements that is closest to a center of the virtual grid.

The operation to spatially prune 704 the new depth sensor measurements to add particular ones of the new depth sensor measurements to the cumulative set [symbol] of depth sensor measurements, may include to, for each of the new depth sensor measurements: determine a minimum distance between the new depth sensor measurement and a closest one of the depth sensor measurements in the cumulative set [symbol] of depth sensor measurements; and add the new depth sensor measurement to the cumulative set [symbol] of depth sensor measurements if the minimum distance is greater than the pruning-based threshold distance.

Alternatively or additionally, the operation to spatially prune 704 the new depth sensor measurements to add particular ones of the new depth sensor measurements to the cumulative set [symbol] of depth sensor measurements, may include to, compare the new depth sensor measurements and the depth sensor measurements in the cumulative set [symbol] using a spatial tree to identify which of the new depth sensor measurements satisfy the condition.

Alternatively or additionally, the operation to spatially prune 704 the new depth sensor measurements adds the particular ones of the new depth sensor measurements to both the cumulative set [symbol] of depth sensor measurements and to a filtered set [symbol] of depth sensor measurements, wherein the filtered set [symbol] of depth sensor measurements only contains the particular ones of the new depth sensor measurements. The operation to update 706 the Gaussian Process model representation of Euclidean distance between points on the at least one physical surface of the environment, is performed using both the cumulative set [symbol] of depth sensor measurements and the filtered set [symbol] of depth sensor measurements.

Before performing the operations to spatially prune 704, operations may initialize the Gaussian Process model, initialize the cumulative set [symbol] of depth sensor measurements, and initialize the filtered set [symbol] of depth sensor measurements. Further operations may then repeat the following in cycles: the operation to acquire 700 new depth sensor measurements [symbol] from the depth sensor; the operation to spatially prune 704 the new depth sensor measurements [symbol] ; and the operation to update 706 the Gaussian Process model. The operation to initialize the Gaussian Process model and the operation to initialize the cumulative set [symbol] of depth sensor measurements are performed once before an initial one of the cycles. The operation to initialize the filtered set [symbol] of depth sensor measurements is performed during each of the cycles.

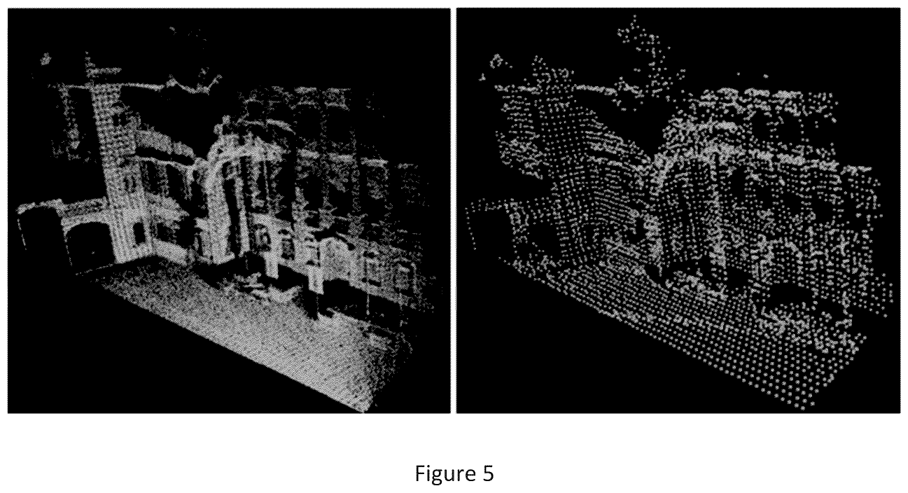

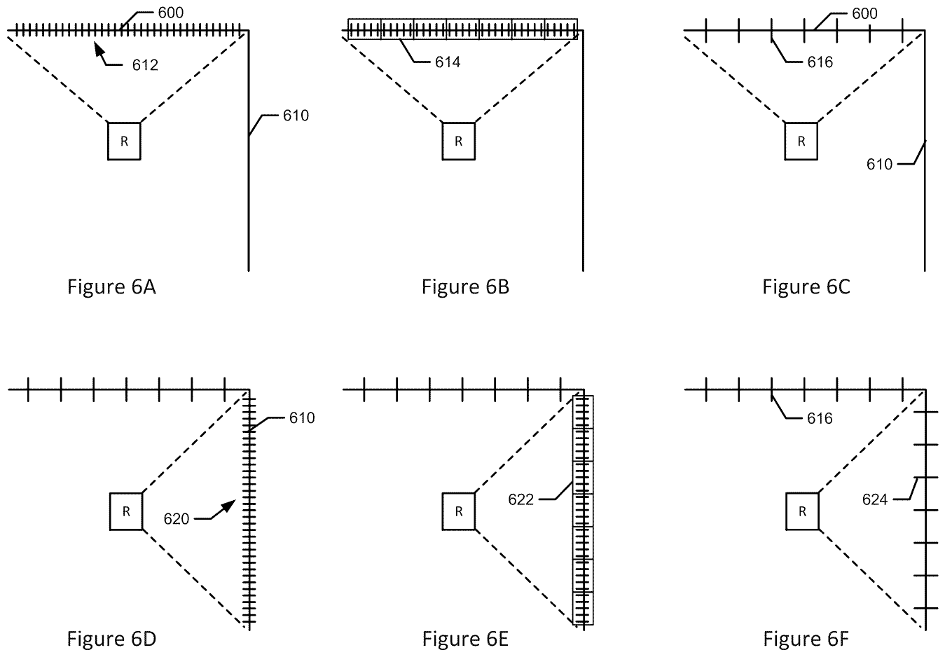

FIG. 3 illustrates a Euclidean distance field represented in a GP model of the environment after updating using a first set of sensor measurements by a spatial sensor of a robot in accordance with some embodiments of the present disclosure. FIG. 4 illustrates a Euclidean distance field represented in the GP model of the environment after further updating using a second set of sensor measurements after the robot has moved performing further sensing using the spatial sensor, in accordance with some embodiments of the present disclosure. A ground-truth map of physical surfaces was used in the simulation, and which was initially unknown to the robot. Small dots along the physical surfaces represent what was current sensor readings from a 360-degree Lidar scanner. Other small dots along the physical surfaces, which are nearly indistinguishable in location from the current sensor reading dots, represent what was the current locations of the inducing points. The meandering lines 300 and 400 represent level curves of what was the current EDF model.

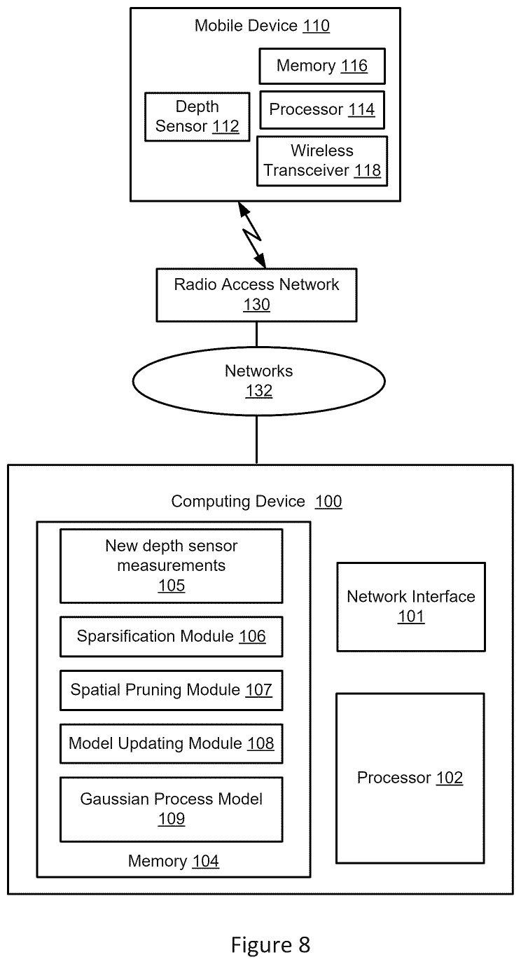

FIG. 8 illustrates a block diagram of components of a system that are configured to operate in accordance with some embodiments of the present disclosure. Referring to FIG. 8, a mobile device 110 includes at least one depth sensor 112 (“depth sensor”), at least one processor 114 (“processor”), at least one memory 116 (“memory”) storing program code executable by the processor 114, and at least one wireless transceiver 118 (“wireless transceiver”) to communicate with a radio access network 130 and other networks 132, e.g., public (e.g., Internet) and/or private networks. The depth sensor 112 may passively or actively sense distance to a real-world surfaces, such as by bouncing a laser (e.g., Lidar), RF signal (e.g., radar), sound (e.g., ultrasonic sensor), etc. on the real-world surface. The depth sensor 112 generates depth sensor measurements. The depth sensor measurements are communicated by the wireless transceiver 118 to a computing device 100.

The computing device 100 includes at least one network interface 101 (“network interface”), at least one processor 102 (“processor”), and at least one memory 104 (“memory”) storing program code executable by the processor 102. The network interface is configured to communicate with the mobile device 110. The memory 104 can store new depth sensor measurements 105 received from the mobile device 110, a sparsification module 106 which performs operations to sparsify the new depth sensor measurements, a spatial pruning module 107 which performs operations to spatially prune the sparsified new depth sensor measurements, and a model updating module 108 which performs operations to update a Gaussian Process model 109.

One or more of the modules 106, 107, and/or 108, and/or the Gaussian Process model 109 may be located in the mobile device 110 and/or in other network nodes.

### Further Definitions and Embodiments

In the above description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts.

Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

The following listing of documents are referenced herein by their bracketed number:
[1] T. D. Bui, C. Nguyen, and R. E. Turner, “Streaming sparse Gaussian process approximations”, in Advances in Neural Information Processing Systems 30 (NIPS 2017), NeurIPS Proceedings.
[2] B. Lee, C. Zhang, Z. Huang, and D. D. Lee, “Online continuous mapping using gaussian process implicit surfaces”, in 2019 International Conference on Robotics and Automation (ICRA), pages 6884-6890, 2019, IEEE.
[3] F. S. Barbosa, and J. Tumova, “Risk-Aware Navigation on Smooth Approximations of Euclidean Distance Fields Among Dynamic Obstacles”, http://urn.kb.se/resolve?urn=urn:nbn:se:kth:diva-307093, 2022, KTH.

1. A method of spatially modeling an environment comprising:
acquiring new depth sensor measurements [symbol] from a depth sensor indicating points on at least one physical surface of the environment;
spatially pruning the new depth sensor measurements [symbol] to add particular ones of the new depth sensor measurements to a cumulative set [symbol] of depth sensor measurements which satisfy a condition for being at least a pruning-based threshold distance away from any depth sensor measurements already in the cumulative set [symbol] of depth sensor measurements; and
updating a Gaussian Process model representation of a Euclidean distance field on the at least one physical surface of the environment using at least the particular ones of the new depth sensor measurements added to the cumulative set [symbol] of depth sensor measurements.

2. The method of claim 1, before the spatial pruning, further comprising:
sparsifying the new depth sensor measurements [symbol] to not include any of the new depth sensor measurements that are within a sparsity-based threshold distance away from other of the new depth sensor measurements.

3. The method of claim 2, wherein the sparsifying of the new depth sensor measurements comprises:
for each virtual grid in an array of virtual grids that are arranged along at least part of a range of the new depth sensor measurements, leaving only one of the new depth sensor measurements that is within the virtual grid and satisfies a condition for being at least the sparsity-based threshold distance away from the new depth sensor measurements within adjacent virtual grids in the array.

4. The method of claim 3, wherein the sparsifying of the new depth sensor measurements further comprises:
for each virtual grid in an array of virtual grids that are arranged along at least part of the range of the new depth sensor measurements, leaving only one of the new depth sensor measurements that is within the virtual grid and satisfies the condition for being at least the sparsity-based threshold distance away from the new depth sensor measurements within adjacent virtual grids in the array and providing more even distribution relative to the new depth sensor measurements within the adjacent virtual grids in the array.

5. The method of claim 3, wherein the sparsifying of the new depth sensor measurements further comprises:
downsampling the new depth sensor measurements using a voxel grid filter operating with a minimum virtual grid size defined based on the sparsity-based threshold distance.

6. The method of claim 5, wherein the downsampling of the new depth sensor measurements using a voxel grid filter operating with a minimum virtual grid size defined based on the sparsity-based threshold distance, comprises:
downsampling the new depth sensor measurements using the voxel grid filter operating with a minimum virtual grid size that is greater than sparsity-based threshold distance; and
within each of the virtual grids, selecting one of the new depth sensor measurements that is closest to a center of the virtual grid.

7. The method of claim 1, wherein the spatial pruning of the new depth sensor measurements to add particular ones of the new depth sensor measurements to the cumulative set [symbol] of depth sensor measurements, comprises:
for each of the new depth sensor measurements,
determining a minimum distance between the new depth sensor measurement and a closest one of the depth sensor measurements in the cumulative set [symbol] of depth sensor measurements; and
adding the new depth sensor measurement to the cumulative set [symbol] of depth sensor measurements if the minimum distance is greater than the pruning-based threshold distance.

8. The method of claim 1, wherein the spatial pruning of the new depth sensor measurements to add particular ones of the new depth sensor measurements to the cumulative set [symbol] of depth sensor measurements, comprises:
comparing the new depth sensor measurements and the depth sensor measurements in the cumulative set [symbol] using a spatial tree to identify which of the new depth sensor measurements satisfy the condition.

9. The method of claim 1, wherein:
the spatial pruning of the new depth sensor measurements adds the particular ones of the new depth sensor measurements to both the cumulative set [symbol] of depth sensor measurements and to a filtered set [symbol] of depth sensor measurements, wherein the filtered set [symbol] of depth sensor measurements only contains the particular ones of the new depth sensor measurements; and
the updating of the Gaussian Process model representation of a Euclidean distance field of the environment, is performed using both the cumulative set [symbol] of depth sensor measurements and the filtered set [symbol] of depth sensor measurements.

10. The method of claim 9, further comprising:
before performing the spatial pruning,
initializing the Gaussian Process model,
initializing the cumulative set [symbol] of depth sensor measurements, and
initializing the filtered set [symbol] of depth sensor measurements; and
repeating in cycles,
the acquiring of new depth sensor measurements [symbol] from the depth sensor, the spatial pruning of the new depth sensor measurements [symbol] and
the updating of the Gaussian Process model,
wherein the initializing of the Gaussian Process model and the initializing of the cumulative set [symbol] of depth sensor measurements are performed once before an initial one of the cycles, and
wherein the initializing of the filtered set [symbol] of depth sensor measurements is performed during each of the cycles.

11. A computing device comprising:
at least one processor; and
at least one memory storing instructions executable by the at least one processor to perform operations comprising to:
acquire new depth sensor measurements [symbol] from a depth sensor indicating points on at least one physical surface of the environment;
spatially prune the new depth sensor measurements [symbol] to add particular ones of the new depth sensor measurements to a cumulative set [symbol] of depth sensor measurements which satisfy a condition for being at least a pruning-based threshold distance away from any depth sensor measurements already in the cumulative set [symbol] of depth sensor measurements; and
update a Gaussian Process model representation of a Euclidean distance field on the at least one physical surface of the environment using at least the particular ones of the new depth sensor measurements added to the cumulative set [symbol] of depth sensor measurements.

12. The computing device of claim 10, before the operation spatially prune, further comprising an operation to:
sparsify the new depth sensor measurements [symbol] to not include any of the new depth sensor measurements that are within a sparsity-based threshold distance away from other of the new depth sensor measurements.

13. The computing device of claim 12, wherein the operation to sparsify the new depth sensor measurements comprises to:
for each virtual grid in an array of virtual grids that are arranged along at least part of a range of the new depth sensor measurements, leave only one of the new depth sensor measurements that is within the virtual grid and satisfies a condition for being at least the sparsity-based threshold distance away from the new depth sensor measurements within adjacent virtual grids in the array.

14. The computing device of claim 13, wherein the operation to sparsify the new depth sensor measurements comprises to:
for each virtual grid in an array of virtual grids that are arranged along at least part of the range of the new depth sensor measurements, leave only one of the new depth sensor measurements that is within the virtual grid and satisfies the condition for being at least the sparsity-based threshold distance away from the new depth sensor measurements within adjacent virtual grids in the array and providing more even distribution relative to the new depth sensor measurements within the adjacent virtual grids in the array.

15. The computing device of claim 14, wherein the operation to sparsify the new depth sensor measurements comprises to:
downsample the new depth sensor measurements using a voxel grid filter operating with a minimum virtual grid size defined based on the sparsity-based threshold distance.

16. The computing device of claim 15, wherein the operation to downsample the new depth sensor measurements using a voxel grid filter operating with a minimum virtual grid size defined based on the sparsity-based threshold distance, comprises to:
downsample the new depth sensor measurements using the voxel grid filter operating with a minimum virtual grid size that is greater than sparsity-based threshold distance; and
within each of the virtual grids, select one of the new depth sensor measurements that is closest to a center of the virtual grid.

17. The computing device of claim 11, wherein the operation to spatially prune the new depth sensor measurements to add particular ones of the new depth sensor measurements to the cumulative set [symbol] of depth sensor measurements, comprises to:
for each of the new depth sensor measurements,
determine a minimum distance between the new depth sensor measurement and a closest one of the depth sensor measurements in the cumulative set [symbol] of depth sensor measurements; and
add the new depth sensor measurement to the cumulative set [symbol] of depth sensor measurements if the minimum distance is greater than the pruning-based threshold distance.

18. The computing device of claim 11, wherein the operation to spatially prune the new depth sensor measurements to add particular ones of the new depth sensor measurements to the cumulative set [symbol] of depth sensor measurements, comprises to:
compare the new depth sensor measurements and the depth sensor measurements in the cumulative set [symbol] using a spatial tree to identify which of the new depth sensor measurements satisfy the condition.

19. The computing device of claim 11, wherein:
the operation to spatially prune the new depth sensor measurements adds the particular ones of the new depth sensor measurements to both the cumulative set [symbol] of depth sensor measurements and to a filtered set [symbol] of depth sensor measurements, wherein the filtered set [symbol] of depth sensor measurements only contains the particular ones of the new depth sensor measurements; and
the operation to update the Gaussian Process model representation of Euclidean distance between points on the at least one physical surface of the environment, is performed using both the cumulative set [symbol] of depth sensor measurements and the filtered set [symbol] of depth sensor measurements.

20. The computing device of claim 19, wherein the operations further comprise to:
before performing the spatially pruning,
initialize the Gaussian Process model,
initialize the cumulative set [symbol] of depth sensor measurements, and
initialize the filtered set [symbol] of depth sensor measurements; and
repeat in cycles,
the operation to acquire new depth sensor measurements [symbol] from the depth sensor, the operation to spatially prune the new depth sensor measurements [symbol] and
the operation to update the Gaussian Process model,
wherein the operation to initialize the Gaussian Process model and to initialize the cumulative set [symbol] of depth sensor measurements are performed once before an initial one of the cycles, and
wherein the operation to initialize the filtered set [symbol] of depth sensor measurements is performed during each of the cycles.
